(19) United States
(12) Patent Application Publication
(10) Pub. No.: US 2009/0174659 A1
(43) Pub. Date: Jul. 9, 2009

(54) WIRELESS MOUSE

(75) Inventors: Hsiao-Lung Chiang, Taipei (TW); Chin-Ping Chan, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/060,972

(22) Filed: Apr. 2, 2008

(30) Foreign Application Priority Data
Jan. 4, 2008 (TW) 097100400

(51) Int. Cl. G06F 3/033

(52) U.S. Cl. 345/163

(57) ABSTRACT

The present invention provides a wireless mouse including a mouse body, a wireless signal receiver, a battery cover and a receiver holder. One end of the battery cover is pivotally connected to the mouse body such that the other end of the battery cover is rotatable with respect to the mouse body. The receiver holder is fixed on the battery cover for receiving the wireless signal receiver therein.

### FIELD OF THE INVENTION

The present invention relates to a wireless mouse, and more particularly to a wireless mouse for holding a wireless signal receiver therein.

### BACKGROUND OF THE INVENTION

With rapid development of electronic and information industries, computers and the peripheral device thereof become essential parts in our daily lives. For example, mice are important peripheral devices of computers for establishing contact between the personal computers and the users. For helping the user well operate the computer, many novel mice (e.g. wireless mice) with expanded functions are developed in views of humanization and user-friendliness.

Conventionally, a mouse is communicated with a computer via wire linkage. The wire linkage is very troublesome and inconvenient. Instead of using the connecting wire, a corresponding wireless signal receiver is used for receiving wireless signals issued from the mouse body when the wireless mouse is operated. Since no additional connecting wire is required to connect the wireless mouse with the computer, the use of the wireless mouse is more convenient. In addition to the wireless mouse, other wireless peripheral devices such as wireless earphones, wireless keyboards and the like are communicated with the computer according to a wireless transmission technology. Among these wireless peripheral devices, the wireless mouse is very popular.

Although the wireless mouse is convenient because no signal wire is required, there are still some several drawbacks. For example, when the wireless mouse is operated, a corresponding wireless signal receiver is necessary. In a case that this wireless mouse is used in other places, the user should carry the corresponding wireless signal receiver at the same time. In other words, if the wireless mouse and the wireless signal receiver are separately held, the probability of losing either the wireless mouse or the wireless signal receiver is increased. Under this circumstance, the wireless mouse fails to be normally operated. For solving such a problem, it is important to provide a holding structure for holding the corresponding wireless signal receiver therein.

FIG. 1 is a schematic perspective view of a conventional wireless mouse. The wireless mouse 1 includes a mouse body 101 and a wireless signal receiver 102. The mouse body 101 has a holding portion 103 for accommodating the wireless signal receiver 102 therein. For fixing the wireless signal receiver 102 in the holding portion 103, a fixing element such as a doorlock element (not shown) is disposed in the holding portion 103. After the wireless signal receiver 102 is accommodated within the holding portion 103, the wireless signal receiver 102 is clasped and fixed by the doorlock element. In response to an external force exerted on the doorlock element, the wireless signal receiver 102 is disengaged from the doorlock element such that a portion of the wireless signal receiver 102 is elastically escaped from the holding portion 103. Under this circumstance, the user may withdraw the wireless signal receiver 102.

The holding structure for holding the wireless signal receiver 102 as shown in FIG. 1, however, still has some drawbacks. For example, after the wireless signal receiver 102 is detached from the mouse body 101, an entrance of the holding portion 103 is exposed. If no additional sheltering door is used for sheltering the entrance of the holding portion 103, the components inside the mouse body 101 are possibly contaminated by external dust. Moreover, the doorlock element within the holding portion 103 is often suffered from elastic fatigue after used for a long term. Due to elastic fatigue, the fastening effect is impaired and thus the wireless signal receiver 102 readily falls down. Since the doorlock element for facilitating fixing the wireless signal receiver 102 in the holding portion 103 and/or elastically escaping the wireless signal receiver 102 from the holding portion 103 is additional cost, this wireless mouse 1 is not cost-effective.

Therefore, there is a need of providing an improved wireless mouse to obviate the drawbacks encountered from the prior art.

### SUMMARY OF THE INVENTION

It is an object of the present invention to provide a wireless mouse having a mechanism to facilitate inserting/removing the wireless signal receiver into/from the receiver holder of the mouse body without the use of doorlock element.

In accordance with an aspect of the present invention, there is provided a wireless mouse. The wireless mouse includes a mouse body, a wireless signal receiver, a battery receptacle, a battery cover and a receiver holder. The mouse body generates a wireless signal. The wireless signal receiver is used for receiving the wireless signal. The battery receptacle is disposed within the mouse body for accommodating a battery therein, wherein the battery receptacle has a battery access inlet. The battery cover is pivotally coupled to the mouse body and rotatable with respect to the mouse body. The receiver holder is fixed on the battery cover for accommodating the wireless signal receiver therein. When the battery access inlet is sheltered by the battery cover, the receiver holder is disposed within the mouse body. When the battery access inlet is exposed, the receiver holder is exposed and thus the user may either insert the wireless signal receiver into the receiver holder or withdraw the wireless signal receiver from the receiver holder.

In an embodiment, the wireless signal receiver is electrically connected to a computer so as to transmit the wireless signal to the computer.

Preferably, the wireless signal receiver is electrically connected to the computer through a universal serial bus (USB).

In an embodiment, the receiver holder includes a fixing part coupled to the battery cover and a plurality of ribs for clamping the wireless signal receiver therebetween.

Preferably, the fixing part and the ribs are integrally formed.

In an embodiment, the fixing part receiver holder is fixed on the battery cover by screwing.

Preferably, the receiver holder is made of plastic material.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional wireless mouse;

FIG. 2A is a schematic side view of a wireless mouse according to a preferred embodiment of the present invention;

FIG. 2B is a schematic side view of the wireless mouse of FIG. 2A, in which the battery cover is opened;

FIG. 3A is a schematic exploded view illustrating the relation between the receiver holder and the battery cover;

FIG. 3B is a schematic assembled view illustrating the combination of the receiver holder and the battery cover;

FIG. 4A is a schematic top view illustrating that the wireless signal receiver is detached from the receiver holder;

FIG. 4B is a schematic top view illustrating that the wireless signal receiver is held within the receiver holder; and

FIG. 5 is a schematic rear view illustrating the wireless mouse of FIG. 2B.

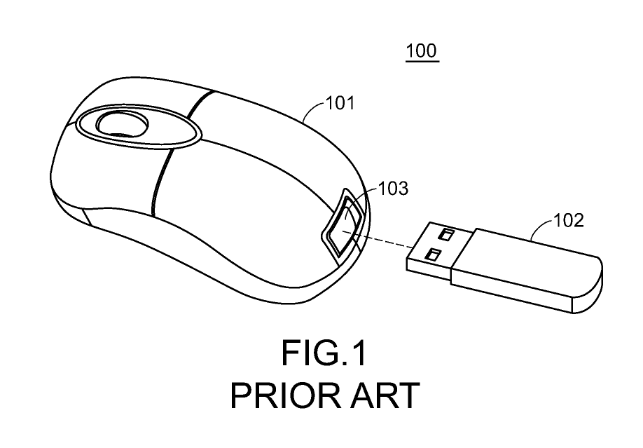

### DETAILED DESCRIPTION OF THE PREFERRED EMBODIMENT

For obviating the drawbacks encountered from the prior art, the present invention provides an improved wireless mouse. The wireless signal receiver of the wireless mouse is connected to a universal serial bus (USB) port of a computer. Therefore, the signals generated from the wireless mouse can be transmitted to the computer via the wireless signal receiver.

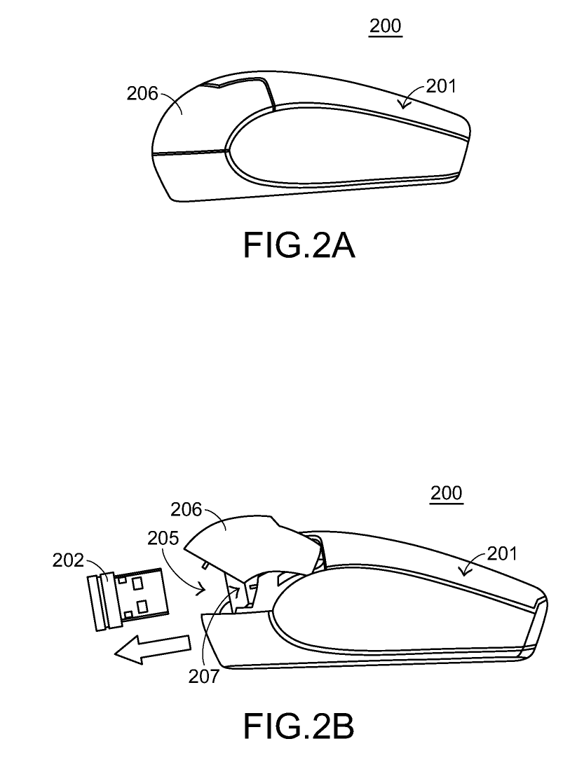

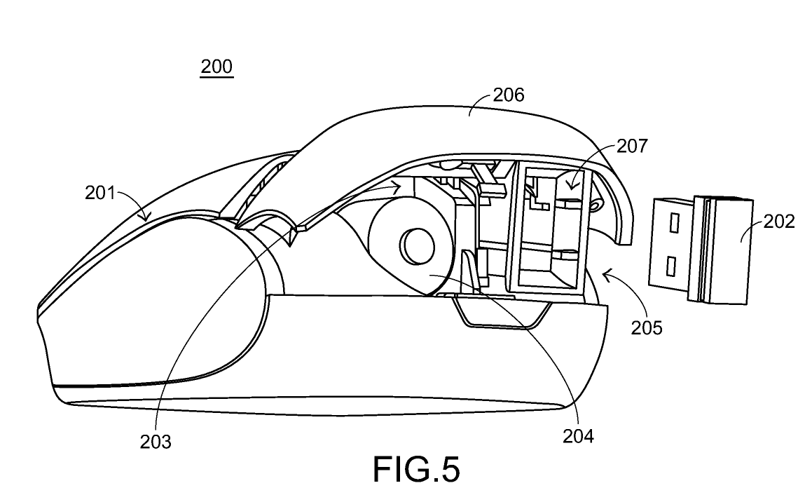

Referring to FIG. 2A, a schematic side view of a wireless mouse according to a preferred embodiment of the present invention is illustrated. As shown in FIG. 2A, the wireless mouse 200 includes a mouse body 201 and a battery cover 206. When the battery cover 206 is opened, a battery receptacle 203 (as shown in FIG. 5) and a receiver holder 207 (as shown in FIG. 5) are exposed. The battery receptacle 203 is disposed within the mouse body 201 for accommodating a battery 204 therein. The receiver holder 207 is attached onto the battery cover 206 for accommodating a wireless signal receiver 202 therein. The battery receptacle 203 has a battery access inlet 205. When the battery access inlet 205 is exposed, the user may replace the battery 20 with a new one. Likewise, when the receiver holder 207 is exposed, the user may insert/remove the wireless signal receiver 202 into/from the receiver holder 207.

As shown in FIG. 2B, the receiver holder 207 is fixed on the battery cover 206. When the battery receptacle 203 is opened, the receiver holder 207 is exposed to the battery access inlet 205.

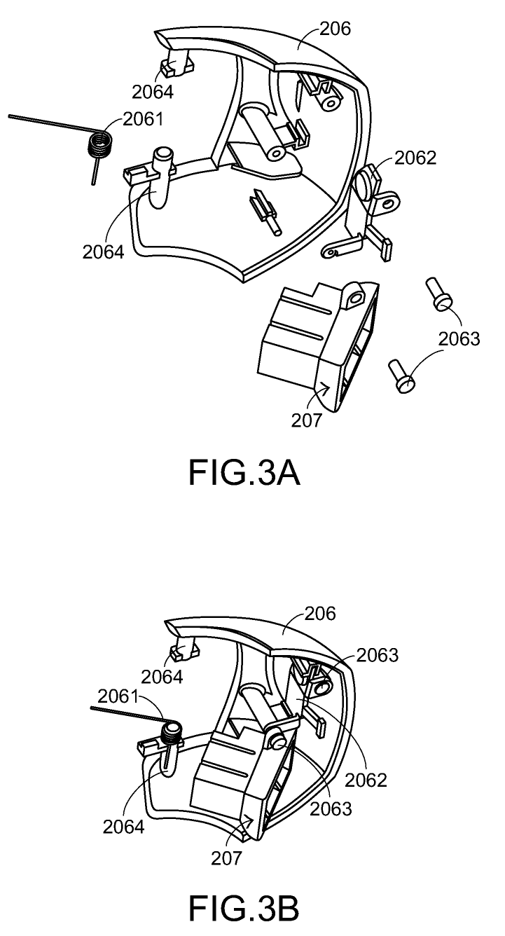

FIG. 3A is a schematic exploded view illustrating the relation between the receiver holder and the battery cover. The components shown in FIG. 3A include the battery cover 206, a spring 2061, a battery leaf spring 2062, a plurality of screws 2063 and the receiver holder 207. The battery cover 206 has pins 2064 to be coupled to the mouse body 201 (as shown in FIG. 2). The battery cover 206 is pivotal about the mouse body 201 with the pins 2064 serving as the rotating shaft, so that the battery cover 206 can be uplifted. Moreover, the spring 2061 is sheathed around a pin 2064 for providing an elastic force onto the battery cover 206 so as to uplift the battery cover 206. For inserting the battery 204 (as shown in FIG. 5) into the battery receptacle 203, the battery 204 needs to be sustained against the battery leaf spring 2062 such that the battery 204 is firmly fixed in the battery receptacle 203. By means of the screws 2063, the battery leaf spring 2062 and the receiver holder 207 are fixed on the battery cover 206. The assembled structure of FIG. 3A is shown in FIG. 3B.

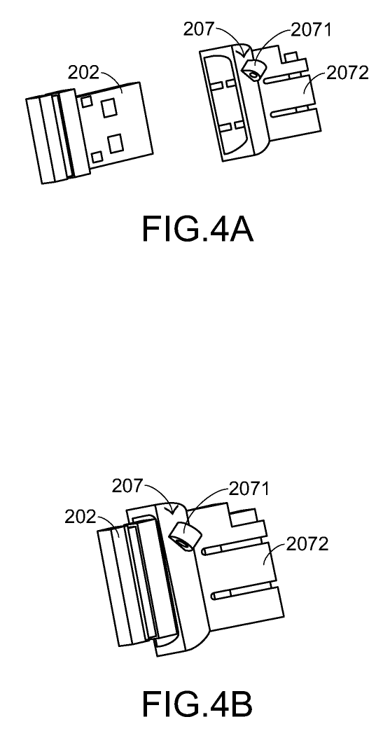

Hereinafter, the relation between the wireless signal receiver 202 and the receiver holder 207 will be illustrated with reference to FIGS. 4A and 4B. FIG. 4A is a schematic top view illustrating that the wireless signal receiver 202 is detached from the receiver holder 207. As shown in FIG. 4A, the receiver holder 207 includes a fixing part 2071 and a plurality of ribs 2072. After a screw 2063 is penetrated through the fixing part 2071 of the receiver holder 207 and then screwed in the battery cover 206, the receiver holder 207 is fixed on the battery cover 206. FIG. 4B is a schematic top view illustrating that the wireless signal receiver 202 has been held in the receiver holder 207. After the wireless signal receiver 202 is held in the receiver holder 207, the ribs 2072 may facilitate clamping the upper and lower surfaces of the wireless signal receiver 202 such that the wireless signal receiver 202 is not easily detached from the receiver holder 207. In this embodiment, the receiver holder 207 is made of plastic material, and the fixing part 2071 and the ribs 2072 are integrally formed with the main body of the receiver holder 207.

The detailed structure of the wireless mouse of the present invention will be illustrated as follows. FIG. 5 is a schematic rear view illustrating the wireless mouse of the present invention. The wireless mouse 200 includes the mouse body 201, the wireless signal receiver 202, the battery receptacle 203, the battery 204, the battery cover 206 and the receiver holder 207. The battery cover 206 is pivotally coupled to the mouse body 201 and rotatable with respect to the mouse body 201. The battery cover 206 is selectively opened or closed to expose or shelter the battery access inlet 205. The receiver holder 207 is disposed at one side of the battery receptacle 203 and fixed on the battery cover 206. When the battery cover 206 is uplifted to expose the battery access inlet 205, the receiver holder 207 which is fixed on the battery cover 206 is also exposed. Under this circumstance, the wireless signal receiver 202 can be held in the receiver holder 207.

As previously described, the inner components of the conventional wireless mouse are possibly contaminated after the wireless signal receiver is withdrawn because the entrance of the holding portion of the wireless signal receiver is not sheltered. According to the present invention, since the receiver holder is fixed on the battery cover, the receiver holder is still sheltered by the battery cover after the wireless signal receiver is withdrawn. In other words, since no visible leak is present on the mouse body, the components inside the mouse body will no longer be contaminated by external dust. Moreover, due to the elastic and flexible properties of the plastic receiver holder, the ribs of the receiver holder may facilitate clamping the wireless signal receiver. As a consequence, the doorlock element used in the prior wireless mouse can be dispensed with in order to achieve cost-effectiveness. Since the wireless signal receiver is held in the receiver holder, i.e. the wireless signal receiver is sealed within the mouse body, the probability of losing the wireless signal receiver is minimized even if the ribs are loosened or the clamping effect is reduced. As a result, the wireless mouse of the present invention is advantageous over the conventional wireless mouse in many aspects.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless mouse comprising:
a mouse body generating a wireless signal;
a wireless signal receiver for receiving said wireless signal;
a battery receptacle disposed within said mouse body for accommodating a battery therein, wherein said battery receptacle has a battery access inlet;
a battery cover pivotally coupled to said mouse body and rotatable with respect to said mouse body; and
a receiver holder fixed on said battery cover for accommodating said wireless signal receiver therein, wherein said receiver holder is disposed within said mouse body when said battery access inlet is sheltered by said battery cover, and said receiver holder is exposed when said battery access inlet is exposed, thereby facilitating a user to either insert said wireless signal receiver into said receiver holder or withdraw said wireless signal receiver from said receiver holder.

2. The wireless mouse according to claim 1 wherein said wireless signal receiver is electrically connected to a computer so as to transmit said wireless signal to said computer.

3. The wireless mouse according to claim 2 wherein said wireless signal receiver is electrically connected to said computer through a universal serial bus (USB).

4. The wireless mouse according to claim 1 wherein said receiver holder includes:
a fixing part coupled to said battery cover; and
a plurality of ribs for clamping said wireless signal receiver therebetween.

5. The wireless mouse according to claim 4 wherein said fixing part and said ribs are integrally formed.

6. The wireless mouse according to claim 4 wherein said fixing part receiver holder is fixed on said battery cover by screwing.

7. The wireless mouse according to claim 1 wherein said receiver holder is made of plastic material.
